(19) United States
(12) Patent Application Publication
(10) Pub. No.: US 2025/0222350 A1
(43) Pub. Date: Jul. 10, 2025

(54) VIRTUAL WORLD-BASED RENDERING METHOD AND APPARATUS, DEVICE, AND STORAGE MEDIUM

(71) Applicant: Tencent Technology (Shenzhen) Company Limited, Shenzhen (CN)

(72) Inventor: Boyuan Pan, Shenzhen (CN)

(21) Appl. No.: 19/092,255

(22) Filed: Mar. 27, 2025

Related U.S. Application Data
(63) Continuation of application No. PCT/CN2024/073170, filed on Jan. 19, 2024.

(30) Foreign Application Priority Data
Mar. 31, 2023 (CN) 202310363618.3

(51) Int. Cl. A63F 13/352; A63F 13/355; G06T 15/20

(52) U.S. Cl. CPC A63F 13/352; A63F 13/355; G06T 15/20

(57) ABSTRACT

A virtual world-based rendering method and systems are described, relating to human-computer interaction technologies. A method is performed by a rendering node device; at least one rendering server group included in the rendering node device has a one-to-one correspondence with at least one regional server configured to deploy a virtual world; each regional server corresponds to one virtual sub-world in the virtual world. The method includes: receiving first view data transmitted by a first regional server of at least one regional server; transmitting the first view data to at least one rendering server in a first rendering server group; and transmitting a virtual world picture rendered by the at least one rendering server to a terminal accessing the at least one rendering server. This application can improve the efficiency of interaction between a user and the virtual world in a scenario of cloud technologies such as cloud gaming.

### RELATED APPLICATION

This application is a continuation application of PCT Application PCT/CN2024/073170, filed Jan. 19, 2024, which claims priority to Chinese Patent Application No. 202310363618.3, filed on Mar. 31, 2023, each entitled “VIRTUAL WORLD-BASED RENDERING METHOD AND APPARATUS, DEVICE, AND STORAGE MEDIUM”, and each of which is incorporated herein by reference in its entirety.

### FIELD

Aspects described herein relate to the field of human-computer interaction, and in particular, to a virtual world-based rendering method and apparatus, a device, and a storage medium.

### BACKGROUND

With continuous advancement of network technologies, virtual world products based on cloud technologies (such as cloud gaming) have become increasingly diverse.

In the related art, a virtual world may be typically implemented based on a regional server; for example, one regional server may maintain a complete virtual world based on the cloud technology. Terminals of a plurality of players may access this regional server to engage in gaming in the virtual world. The regional server performs logical computation and picture rendering for gaming, and transmits rendered pictures to the terminal of each player for display.

However, because one regional server is limited in computing capacity, when a large number of terminals access one regional server, the regional server may have a delay in performing the logical computation and picture rendering, causing phenomena such as frame freezing on a terminal side, and further affecting the efficiency of interaction between a user and the virtual world.

### SUMMARY

This application provides a virtual world-based rendering method and apparatus, a device, and a storage medium. The technical solutions are implemented as follows:

according to an aspect described herein, a virtual world-based rendering method is provided, and performed by a rendering node device; at least one rendering server group included in the rendering node device is in a one-to-one correspondence with at least one regional server configured to deploy a virtual world; each regional server corresponds to one virtual sub-world in the virtual world; the method includes:

receiving first view data transmitted by a first regional server of the at least one regional server, the first view data being configured for indicating a visual element included in a first virtual sub-world, and the first virtual sub-world being a virtual sub-world corresponding to the first regional server in the virtual world;

transmitting the first view data to at least one rendering server in a first rendering server group, the first rendering server group being a rendering server group corresponding to the first virtual sub-world in the rendering node device; and

transmitting a virtual world picture rendered by the at least one rendering server to a terminal accessing the at least one rendering server.

According to an aspect described herein, a virtual world-based rendering method is provided, and performed by a first regional server, the first regional server is any regional server of at least one regional server configured to deploy a virtual world; each regional server corresponds to the virtual world is respectively connected with at least one rendering node device, and at least one rendering server group included in each rendering node device is in a one-to-one correspondence with the at least one regional server; each regional server corresponds to one virtual sub-world in the virtual world; the method includes:

generating first view data, the first view data being configured for indicating a visual element included in a first virtual sub-world, and the first virtual sub-world being a virtual sub-world corresponding to the first regional server in the virtual world; and

transmitting the first view data respectively to the at least one rendering node device, whereby the rendering node device transmits the first view data to at least one rendering server in a first rendering server group, and transmits a virtual world picture rendered by the at least one rendering server to a terminal accessing the at least one rendering server, the first rendering server group being a rendering server group corresponding to the first virtual sub-world in the rendering node device.

According to an aspect described herein, a virtual world-based rendering method is provided, and applied to a virtual world system, the system includes at least one regional server configured to deploy a virtual world, and at least one rendering node device correspondingly connected respectively with each regional server, and at least one rendering server group included in each rendering node device is in a one-to-one correspondence with the at least one regional server; each regional server corresponds to one virtual sub-world in the virtual world; the method includes:

generating, by using a first regional server, first view data, the first view data being configured for indicating a visual element included in a first virtual sub-world, and the first virtual sub-world being a virtual sub-world corresponding to the first regional server in the virtual world;

transmitting, by using the first regional server, the first view data respectively to the at least one rendering node device;

transmitting, by using the rendering node device, the first view data to at least one rendering server in a first rendering server group, the first rendering server group being a rendering server group corresponding to the first virtual sub-world in the rendering node device; and

transmitting, by using the rendering node device, a virtual world picture rendered by the at least one rendering server to a terminal accessing the at least one rendering server.

According to an aspect described herein, a virtual world-based rendering apparatus is provided and configured to deploy at least one regional server of the virtual world, and the at least one regional server is in a one-to-one correspondence with at least one rendering server group included in a rendering node device; each regional server corresponds to one virtual sub-world in the virtual world; the apparatus includes:

a view receiving module, configured to receive first view data transmitted by a first regional server of the at least one regional server, the first view data being configured for indicating a visual element included in a first virtual sub-world, and the first virtual sub-world being a virtual sub-world corresponding to the first regional server in the virtual world;

a view transmitting module, configured to transmit the first view data to at least one rendering server in a first rendering server group, the first rendering server group being a rendering server group corresponding to the first virtual sub-world in the rendering node device; and

a picture transmitting module, configured to transmit a virtual world picture rendered by the at least one rendering server to a terminal accessing the at least one rendering server.

According to an aspect described herein, a virtual world-based rendering apparatus is provided, a first regional server being any regional server of at least one regional server configured to deploy a virtual world; each regional server corresponding to the virtual world is respectively connected with at least one rendering node device, and at least one rendering server group included in each rendering node device is in a one-to-one correspondence with the at least one regional server; each regional server corresponds to one virtual sub-world in the virtual world; the apparatus includes:

a view generating module, configured to generate first view data, the first view data being configured for indicating a visual element included in a first virtual sub-world, and the first virtual sub-world being a virtual sub-world corresponding to the first regional server in the virtual world; and

a view transmitting module, configured to transmit the first view data respectively to the at least one rendering node device, whereby the rendering node device transmits the first view data to at least one rendering server in a first rendering server group and transmits a virtual world picture rendered by the at least one rendering server to a terminal accessing the at least one rendering server, the first rendering server group being a rendering server group corresponding to the first virtual sub-world in the rendering node device.

The beneficial effects brought by the technical solutions provided by this application at least include:

the virtual world system is divided into at least one regional server and at least one rendering node device, each regional server may be connected respectively with the at least one rendering node device, each regional server corresponds to the respective virtual sub-world, when performing the cloud rendering, the regional server is responsible for logical computation of the virtual world, and allocates the view data obtained by computation to each rendering node device, and after rendering is performed by each rendering node device, the virtual world picture obtained by rendering is transmitted to the accessing terminal for displaying; and in the foregoing solution, each regional server is only responsible for the logical computation of the corresponding virtual sub-world in the virtual world, and can effectively control computation load of each regional server; and in addition, the rendering tasks are performed by at least one rendering node device, and the regional server does not need to undertake the rendering task, whereby the computation load of the regional server can be further reduced. Therefore, the system including the foregoing regional server and the rendering node device can maintain the smoothness of the logical computation and picture rendering of the virtual world in a case of accommodating a large number of accessing terminals, thereby enhancing the efficiency of interaction between the user and the virtual world.

### BRIEF DESCRIPTION OF THE DRAWINGS

FIG. 1 is an architecture diagram of a regional server of a virtual world according to this application.

FIG. 2 is a flowchart of a virtual world-based rendering method according to an aspect described herein.

FIG. 3 is a hardware architecture diagram of cloud gaming according to this application.

FIG. 4 is a flowchart of a virtual world-based rendering method according to another aspect described herein.

FIG. 5 is a flowchart of a virtual world-based rendering method according to another aspect described herein.

FIG. 6 is a schematic diagram of a terminal access process according to an aspect shown in FIG. 5.

FIG. 7 is a structural diagram of hardware deployment of a cloud gaming world according to one or more aspects described herein.

FIG. 8 is a schematic diagram of a connection between a regional server and a local cloud node according to one or more aspects described herein.

FIG. 9 is a schematic structural diagram of a local cloud node according to one or more aspects described herein.

FIG. 10 is a schematic diagram of generation and transmission of a gaming picture according to one or more aspects described herein.

FIG. 11 is a schematic diagram of propagation of a gaming event according to one or more aspects described herein.

FIG. 12 is a structural block diagram of a virtual world-based rendering apparatus according to an illustrative aspect.

FIG. 13 is a structural block diagram of a virtual world-based rendering apparatus according to another illustrative aspect.

FIG. 14 is a structural block diagram of a computer device according to an illustrative aspect described herein.

### DESCRIPTION OF ASPECTS

To make the objectives, technical solutions, and advantages described herein clearer, the following further describes implementations described herein in detail with reference to the accompanying drawings.

Exemplary or illustrative aspects are described in detail herein, and examples of the exemplary aspects are shown in the accompanying drawings. When the following description involves the accompanying drawings, unless otherwise indicated, same numerals in different accompanying drawings represent the same or similar elements. The implementations described in the following exemplary aspects do not represent all implementations consistent with this application. On the contrary, the implementations are only examples of apparatuses and methods consistent with some aspects described herein as claimed in claims.

Terms used in this application are for the purpose of describing specific aspects only and are not intended to limit this application. The singular forms of “a” and “the” used in this application and the appended claims are intended to include the plural forms as well, unless the context clearly indicates otherwise. The term “and/or” used herein indicates and includes any or all possible combinations of one or more associated listed items.

Although the terms such as first, second, and the like may be used in this application to describe various information, the information is not limited to the terms. These terms are merely used to distinguish between information of the same type. For example, without departing from the scope described herein, a first rendering server group may further be referred to as a second rendering server group, and similarly, the second rendering server group may further be referred to as the first rendering server group. Depending on the context, for example, the word “if” used herein may be interpreted as “while” or “when” or “in response to determination.”

For ease of understanding, nouns involved in this application are first described below.

Game: the game is further referred to as a network game or an online game, and for example, the game may be a multi-player online game that utilizes the Internet as a transmission medium and a server as a processing terminal. The game provided in this aspect is derived from a principle of special relativity in modern physics, and abandons a gaming world view in related technologies. A basic principle of the gaming world view of this aspect is as follows:
Time relativity and local inertial reference frame: In the related art, each server (referred to as a regional server in this aspect) of a game has a global clock (referred to as a virtual time zone in this aspect), and each regional server needs to keep the clock synchronous, namely, similar to absolute time in classic mechanics. However, in a new gaming world view, a global uniform clock does not need to be maintained, and only each independent regional server in the game needs to use the game as a local inertial reference frame to maintain the own clock. For example, the regional server 1 maintains a clock 1, and the clock 1 may be set to 24 hours. The regional server 2 maintains a clock 2, and the clock 2 is set to 48 hours. The clock 1 and the clock 2 are different clocks.
Principle of invariant light speed: In the related art, information transfer time in the game is processed as a delay, and is not taken as a process of the game, and it is assumed in game logic that an information transfer speed is unlimited. However, in a theory of special relativity, the light speed has an upper limit, namely, the information transfer speed is limited. In a new gaming world view, an information transfer process is alternatively taken as a part of the game. For example, if a player traverses from the regional server 1 to the regional server 2, the traversing process is alternatively taken as a part of the game.

Virtual world: the virtual world is displayed or provided by a client corresponding to the game provided in this aspect during running. The virtual world may be a simulation world for a real world, may be a semi-simulation and semi-fictional world, or may be a purely fictional world. The virtual world may include at least one of the following: a two-dimensional virtual world, a 2.5-dimensional virtual world, and a three-dimensional virtual world.

Virtual object: the virtual object refers to a movable object in the virtual world. The movable object may include at least one of the following: a virtual character, a virtual animal, an animated character, and a virtual carrier. In some aspects, in a case that the virtual world is a three-dimensional virtual world, the virtual object may be a three-dimensional virtual model, and each virtual object has own shape and size in the three-dimensional virtual world, and occupies a part of space in the three-dimensional virtual world. In some aspects, the virtual object is a three-dimensional character built based on a three-dimensional human skeleton technology. The virtual object may show different external images by wearing different skins. In some implementations, the virtual object may further be implemented by a 2.5-dimension or 2-dimension model. This is not limited in the aspects described herein.

Virtual element: the virtual element refers to various elements appearing in the virtual world, and is configured for constituting the whole virtual world. The virtual element may include at least one of the following: plots, lakes, sky, various virtual animals, various virtual plants, various virtual buildings, and various virtual items. The virtual object controlled by the player alternatively belongs to one of the virtual elements.

For each virtual element in the virtual world, the element that can be observed by a player/user may be referred to as a visual element.

Regional server: the regional server refers to a regional server, and one regional server corresponds to one server or one server cluster in a physical world. In this aspect described herein, one virtual world corresponds to a plurality of regional servers. The regional servers are not directly connected to each other, but are logically connected to each other through an information transfer node. Each regional server can only transfer information to another regional server that is logically connected to this regional server, but cannot transfer information to another regional server that is not logically connected to this regional server.

In an example, the virtual world corresponding to an entire game is regarded as a spherical shape that run independently (referring to a soccer ball), the virtual world includes a plurality of virtual sub-worlds (referring to each pentagonal area on the soccer ball, the virtual sub-world may further be referred to as a virtual world area of the virtual world, and the plurality of virtual sub-worlds form a completed virtual world), each virtual sub-world corresponds to one regional server, the plurality of virtual sub-worlds are distributed on a spherical surface, each virtual sub-world extends outwards, and the regional server corresponding to the virtual sub-world is in communication connection with a limited quantity of other regional servers through the information transfer node. Each regional server or information transfer node has an information transfer path with N nodes adjacent to the boundary, namely, there is a signal line connected in a physical world, to implement mutual information transmission and receiving.

The server involved in this application may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middle-ware service, a domain name service, a security service, a content delivery network (CDN), and a big data and artificial intelligence (AI) platform. The terminal involved in this application may be a smartphone, a tablet computer, a notebook computer, a desktop computer, a smart speaker, a smart watch, a robot, an in-vehicle terminal, a wearable device, an augmented reality (AR) device, a virtual reality (VR) device, a mixed reality (MR) device, or the like, but is not limited thereto. The terminal and the server may be directly or indirectly connected in a wired or wireless communication manner. This is not limited in the aspects described herein. The terminal in aspects described herein may further be referred to as a terminal device.

Event: the event is a basic unit for running the virtual world corresponding to the entire game in this aspect. By analogy with descriptions of events in the theory of relativity, because of time relativity in this aspect, we cannot say that an event occurs at a particular place, but can only say that an event occurs at a particular time in an inertial reference frame. To be specific, the event permanently occurs at a selected [x, y, z, t], where x, y, and z are values in directions of a horizontal coordinate, a longitudinal coordinate, and a vertical coordinate in an inertial reference frame, and t is a time point in the inertial reference frame. Similarly, the event in the virtual world in this aspect further correspondingly has an event attribute (what event, indicated as what) of the event, a regional server in which the event is located (which inertial reference frame, indicated as which), a logical location in the regional server (a space location in the selected inertial reference frame, indicated as where), and a generation moment in the regional server (generation time in the selected inertial reference frame, indicated as when). Therefore, an event description vector corresponding to the event in this aspect needs to include at least the four aforementioned types of information. For example, the event needs to be described by using at least the following event description vector: [what, which, where, when].

Similarly, the virtual element in the game in this aspect may alternatively be abstracted as an event, a virtual element (which), location in a regional server and a logical location in the regional server (where), and a generation moment in the regional server (when). The only difference from the event is that the virtual element may be finally rendered in the virtual world of the game in this aspect, and may be seen by the user. In this aspect, the event and the virtual element may be mutually converted and interact with each other. The event may generate the virtual element, and the virtual element may further generate the event. This is similar to a relationship between mass and energy in modern physics. The event is more like the energy, and the virtual element is more like the mass. In some aspects, the event corresponds to at least one of virtual energy and virtual mass.

Dispersal event: the dispersal event is one type of the event in this aspect, and is an event including at least two propagation directions. The dispersal event has virtual energy and does not have virtual mass. The dispersal event may be transmitted from the present regional server to all regional servers logically connected to the present regional server, and the virtual energy of the dispersal event may attenuate with a propagation distance. If the virtual energy does not attenuate, the dispersal event may be transmitted permanently without disappearing in the virtual world of the game. When the present regional server performs computation on a same dispersal event transferred from different regional servers to the present regional server at the same time, the virtual energy corresponding to the dispersal event in the present regional server may be accumulated. For example, the dispersal event may be an event that needs to be broadcast or notified, for example: a player obtains a reward, and a player obtains a competition champion.

Unidirectional transferred event: the unidirectional transferred event is one type of the event in this aspect, and is an event in which a single propagation direction and a termination condition are set. A unidirectional transferred event has virtual energy and virtual mass. The virtual energy of the unidirectional transferred event may attenuate with the propagation distance, and the virtual mass keeps unchanged. When the present regional server performs computation on the same unidirectional transferred event transferred from different regional servers to the present regional server, the virtual energy corresponding to the unidirectional transferred event in the present regional server may be accumulated. In some aspects, the termination condition of the unidirectional transferred event includes: at least one of conditions that a set number of propagation times is reached, the virtual energy is less than an energy threshold, an event reaches a specified regional server, and there is no legal propagation direction for continuous propagation. For example, the unidirectional transferred event may be: a cross-regional-server traversing event where a player traverses from one regional server to another regional server, an intra-regional-server traversing event where a player traverses from one computing unit to another computing unit in the same regional server, a cross-regional-server flight event where a virtual item flies from one regional server to another regional server, and an intra-regional-server flight event where a virtual item flies from one computing unit to another computing unit in the same regional server in the same regional server.

Computing unit: the computing unit refers to a plurality of units obtained by

dividing one regional server, and one regional server includes at least two computing units. The computing unit is similar to a plurality of parallel computing cores inside a graphics processing unit (GPU). All events occurring in a same computing cycle and generated by the computing units in a same regional server occur simultaneously in different locations. In one computing unit, it may be assumed that all events occurring within the same computing cycle occur simultaneously in the same location. According to this definition, the effects of the theory of relativity may be neglected due to a short distance, reverting to the principle of classical mechanics. Namely, in a same regional server, all virtual elements and events may be still run directly in a manner of identical clock and computing cycle in the related art.

Shared storage area: the shared storage area is a storage area shared by at least two computing units in a same regional server. One regional server corresponds to one shared storage area, and each computing unit in one regional server corresponds to a sub-area in the shared storage area. The computing units in the same regional server do not transfer information to each other by using a signal line, but implement the information transfer by sharing the shared storage area. For example, the regional server includes a computing unit 1 and a computing unit 2. For the shared storage area corresponding to the regional server, the computing unit 1 corresponds to an area 1 in the shared storage area, the computing unit 2 corresponds to an area 2 in the shared storage area, the computing unit 1 may access the area 1 and the area 2 in the shared storage area, and the computing unit 2 may further access the area 1 and the area 2 in the shared storage area.

Cloud technology: the cloud technology refers to a hosting technology that unifies series of resources such as hardware, software, and networks in a wide area network or a local area network, to implement computation, storage, processing, and sharing of data.

The cloud technology is a generic term of a network technology, an information technology, an integration technology, a management platform technology, an application technology, and the like based on a cloud computing business mode, and can constitute a pool of resources, which is used on demand and is flexible and convenient. The cloud computing technology may become an important support. Back-end services of a technology network system require a huge amount of computing and storage resources, such as video websites, picture websites, and more portal websites. With advanced development and application of the Internet industry, every item may have its own identification mark in the future, which needs to be transmitted to a back-end system for logical processing. Data at different levels may be processed separately, and various types of industrial data require strong system back support, which can only be implemented by cloud computing.

Cloud Gaming: the cloud gaming may further be referred to as gaming on demand, and is an online game technology based on the cloud computing technology. The cloud gaming technology allows a thin client with relatively limited graphic processing and data computing capabilities to run a high-quality game. In a cloud gaming scenario, a game is not run in a player gaming terminal, but is run in a cloud server, and the cloud server renders the gaming scenario into a video and audio stream, and transmits the video and audio stream to the player gaming terminal by using a network. The player gaming terminal does not need to have strong graphic operational and data processing capacity, and only needs to have a basic streaming media playing capability and a capability to obtain instructions inputted by the player and transmit the instructions to the cloud server.

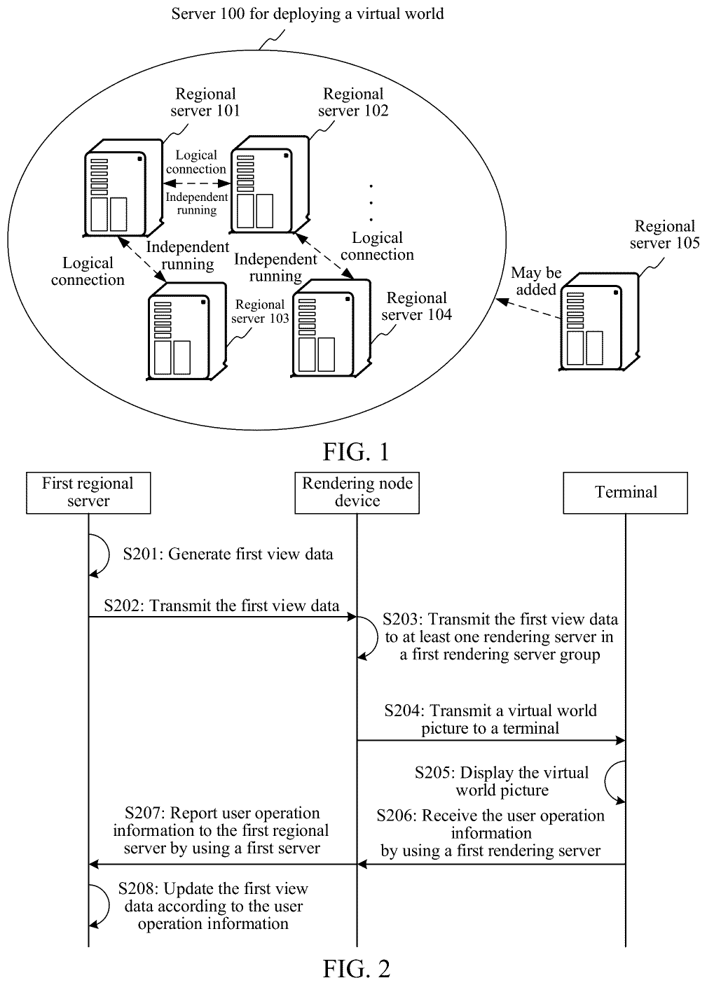

FIG. 1 is an architectural diagram of a regional server of a virtual world according to this application. As shown in FIG. 1, a virtual world (for example, a virtual world corresponding to a game) provided in this aspect is correspondingly provided with at least one regional server that runs independently, and each regional server may be a server or a server cluster in a physical world. For example, a server 100 configured to deploy a virtual world includes a regional server 101, a regional server 102, a regional server 103, and a regional server 104. There is at least one regional server that is logically connected to the at least one regional server. For example, the regional server 101 is logically connected with the regional server 102 and the regional server 103, and the regional server 102 is logically connected with the regional server 101 and the regional server 104. The regional server 101 may transmit data to the regional server 102 or the regional server 103 that are logically connected, or may transmit data to the regional server 104 indirectly by using the regional server 102 or the regional server 103. In this aspect, each regional server only needs to maintain own data and clock cycle. The logical connection is to be understood as a sub-divided virtual connection in a physical connection. For example, the regional server 101 may be logically connected with the regional server 102 and the regional server 103 respectively through a corresponding information transfer node.

When an event is generated in another regional server, before an event signal of the event is transferred to the present regional server, the event may not have any impact on the running of the regional server. Only when the event signal of the event is transferred to the regional server, the event participates in the operation of the present regional server. For example, the present regional server refers to the regional server 102. When the event is generated in the regional server 101, before the event signal is transferred to the regional server 102, the event may not have any impact on the running of the regional server 102. The event participates in the operation of the regional server 102 until the event signal is transferred to the regional server 102.

New virtual sub-worlds may be continuously added to the virtual world. Correspondingly, the server 100 may add new regional servers corresponding to the new virtual sub-worlds. The added new regional server may not have any impact on the existing regional servers. When the event signal in the new regional server is transferred to the existing regional server, the event in the new regional server may affect the running of the existing regional server. For example, the new regional server refers to a regional server 105. When added to the server 100, the regional server 105 may not have any impact on the regional server 101, the regional server 102, the regional server 103, and the regional server 104. Assuming that the regional server 105 is logically connected with the regional server 101, the event in the regional server 105 may affect the running of the regional server 101 only when the event signal in the regional server 105 is transferred to the regional server 101.

FIG. 2 is a flowchart of a virtual world-based rendering method according to an aspect described herein. The method may be applied to a virtual world system. The virtual world system includes at least one regional server configured to deploy a virtual world, and at least one rendering node device correspondingly connected with each regional server respectively. At least one rendering server group included in each rendering node device is in a one-to-one correspondence with the at least one regional server; and each regional server corresponds to one virtual sub-world in the virtual world.

By using the first regional server as an example, the method may be performed by the first regional server and a rendering server in the virtual world system, and a terminal, and the first regional server may be any regional server of the at least one regional server. The method may include the following operations:

Operation 201: The first regional server generates first view data, the first view data being configured for indicating a visual element included in a first virtual sub-world, and the first virtual sub-world being a virtual sub-world corresponding to the first regional server in a virtual world.

The first view data may be configured for describing an image of the first virtual sub-world at a current moment. To be specific, the rendering server may render the image of the first virtual sub-world according to the first view data. For example, the first view data may be configured for describing all the visual elements corresponding to the first virtual sub-world at the current moment, and the rendering server may render all the visual elements corresponding to the first virtual sub-world at the current moment according to the first view data.

In this aspect described herein, the first regional server in a logical server corresponding to the virtual world may perform logical computation on the first virtual sub-world, and generate the first view data based on a result of the logical computation. The result of the logical computation may be implemented as view data of each visual element in the first virtual sub-world, and the view data of each visual element may be synthesized into the foregoing first view data.

The foregoing visual element may refer to any element that needs to be rendered in the virtual sub-world. For example, the foregoing visual element includes, but is not limited to, a virtual object, a virtual building, virtual terrain, a virtual weather effect, virtual vegetation, a virtual item, a virtual marker (such as a light beam), a virtual skill effect, a virtual projectile, and the like in the virtual sub-world.

In a possible implementation, model data of each visual element may be stored in the rendering server, the first view data may indicate current state information of each visual element, the model data is configured for describing a model of the visual element, and the state information is configured for describing a state of the visual element. For example, the first view data may indicate information such as an identifier, a location, a direction, a pose, or whether being removed of each visual element in the first virtual sub-world. The rendering server renders the model of the visual element based on the model data, and determines a state of the model according to the first view data, to render the visual element, so as to obtain an image of the first virtual sub-world through rendering. In this way, only the state information needs to be transferred, whereby data transmission amount can be effectively reduced, and data transmission time is further reduced.

In another possible implementation, the first view data may include the current state information of each visual element in the first virtual sub-world.

In another possible implementation, the first view data may further include the current state information of each of differential visual elements. The differential visual elements are the visual elements of all visual elements in the first virtual sub-world that are changed compared with a preceding moment. The change may include at least one of the following: change of the state information, adding new virtual element to the first virtual sub-world, removing the virtual element from the first virtual sub-world.

For example, it is assumed that the first virtual sub-world includes 10000 visual elements at a first moment, and at a second moment after the first moment, the state information of 100 visual elements of the 10000 visual elements is changed, another 10 visual elements are removed from the first virtual sub-world, and 20 new visual elements are added to the first virtual sub-world. At the second moment, the first view data generated by the first regional server may include the state information of the 100 visual elements with changed information, the state information of the 10 removed visual elements (in this case, only information indicating that the element is removed may be included), and the state information of the 20 newly added visual elements. In this way, by only transmitting the state information of the differential visual elements, the data transmission amount may be further reduced effectively.

Operation 202: The first regional server transmits the first view data respectively to the at least one rendering node device.

In this aspect described herein, after generating the first view data, the first regional server may transmit the first view data to each rendering node device connected with the first regional server. Correspondingly, the at least one rendering node device receives the first view data respectively.

In some aspects, each area in the virtual world system may be connected respectively with all rendering node devices in the virtual world system. In this way, even if a player moves to any regional server, the virtual world system may provide a service to the player. The quantity of the rendering node devices is not limited in this aspect described herein, and may be set and adjusted according to an actual use requirement. For example, the first regional server may be connected with all rendering node devices in the virtual world system, and the at least one rendering node device may be configured to represent all rendering node devices in the virtual world system.

The at least one rendering node device may be distributed in different geographical locations, enabling each terminal to access the nearby rendering node device.

In a possible implementation, each rendering node device further includes at least one access proxy; the at least one access proxy is in a one-to-one correspondence with at least one rendering server group, and at least one access proxy is in a one-to-one correspondence with at least one regional server; and the access proxy is connected with the regional server and the rendering server group, to implement communication between the regional server and the rendering server group, such as transmission of the first view data. In some aspects, the access proxy may be implemented as a server or a circuit configured for data transmission (such as access, output, and allocation). This is not limited in this aspect described herein. The rendering server group may include at least one rendering server, and the rendering server is configured to render an image.

The foregoing process in which the rendering node device receives first view data transmitted by the first regional server may include: the first view data transmitted by the first regional server is received by using a first access proxy. The first access proxy is respectively connected with the at least one rendering server in the first rendering server group. The first access proxy may be an access proxy corresponding to the first regional server in the rendering node device, and the first rendering server group may be a rendering server group corresponding to the first regional server (i.e. the first virtual sub-world) in the rendering node device.

In this aspect described herein, in the rendering node device, one access proxy may be set correspondingly to each regional server, the rendering node device is connected with each regional server through the access proxy, rather than being connected with each regional server through the rendering server in the rendering server group. Thus, when a large number of regional servers and a large number of rendering servers are supported, the quantity of connections between the regional server and the rendering node device can be reduced, and the connection load and network resource occupation between the regional server and the rendering node device can be reduced. In addition, due to the presence of the access proxy, the rendering servers in the rendering server group may be flexibly added and removed inside the rendering node device, thereby supporting the flexible adjustment of the quantity of rendering servers in each rendering server group according to the quantity of accessing terminals.

Operation 203: The rendering node device transmits the first view data to at least one rendering server in the first rendering server group, and the first rendering server group is a rendering server group corresponding to the first virtual sub-world in the rendering node device.

In this aspect described herein, after receiving the first view data, each rendering node device may transmit the first view data to each included first rendering server group. Namely, each rendering node device is provided with the first rendering server group corresponding to the first regional server.

In some aspects, after receiving the first view data, the rendering node device may further transmit the first view data respectively to the at least one rendering server in the first rendering server group through the first access proxy. To be specific, each rendering node device is provided with the first access proxy corresponding to the first regional server.

Operation 204: The rendering node device transmits a virtual world picture rendered by the at least one rendering server to a terminal accessing the at least one rendering server.

In this aspect described herein, each rendering server in the first rendering server group may render the virtual world picture of the first virtual sub-world respectively according to the first view data, and transmit the rendered virtual world picture to the terminal accessing the rendering server, whereby the terminal displays the rendered virtual world picture.

In a cloud gaming scenario, the rendering server may transmit consecutive virtual world pictures of the virtual sub-world to the terminal in a video stream form.

Operation 205: The terminal displays the virtual world picture.

After receiving the foregoing virtual world picture, the terminal may display the foregoing virtual world picture on a display screen.

Operation 206: The rendering node device receives user operation information reported by the first terminal by using the first server.

The first terminal may be any one of terminals accessing the at least one rendering server in the first rendering server group, and the first server may be a rendering server where the first terminal accesses. The user operation information is configured for describing an operation generated by a user for the virtual world by using the terminal, such as a control operation for a virtual object, an adjustment operation for a virtual building, or a use operation for a virtual item. This is not limited in this aspect described herein.

When receiving the user operation performed by the user, the terminal may generate the user operation information based on the user operation, and report the user operation information to the accessed rendering server.

To be specific, the rendering server in this aspect described herein is further responsible for forwarding the user operation information in addition to undertaking a rendering task. In this way, an additional connection established between the terminal and the regional server may be avoided, thereby reducing complexity of the system and reducing connection load of the regional server.

Operation 207: The rendering node device reports the user operation information to the first regional server by using the first server.

When reporting the user operation information to the corresponding regional server, the rendering server may generate an event based on the user operation information, and report the user operation information to the regional server in a form of an event.

Alternatively, the rendering server may further report the user operation information directly to the regional server, and the regional server generates a corresponding event according to the user operation information.

In some aspects, the rendering node device may encapsulate the user operation information into an event in the virtual world by using the first server, and forward the event to the first regional server by using the first access proxy. Correspondingly, the first regional server receives user operation data transmitted by the first access proxy.

Operation 208: The first regional server updates the first view data based on the user operation information.

In this aspect described herein, each regional server may update the first view data according to the received/generated event. For example, based on the user operation information, the first regional server performs logical processing on the first virtual sub-world (for example, adjusts state information of a virtual object, a virtual building, a virtual item, or the like), to obtain the updated first view data.

In addition to the event corresponding to the user operation information of the corresponding terminal, the event received/generated by the regional server may further include the event received/generated in another manner. For example, the event may include the event occurring in the current virtual sub-world, or may include the event transferred from another regional server.

In conclusion, in the solution shown in this aspect described herein, the virtual world system is divided into at least one regional server and at least one rendering node device, each regional server may be connected respectively with the at least one rendering node device, each regional server corresponds to the respective virtual sub-world, when performing the cloud rendering, the regional server is responsible for logical computation of the virtual world, and allocates the view data obtained by computation to each rendering node device, and after rendering is performed by each rendering node device, the virtual world picture obtained by rendering is transmitted to an accessed terminal for displaying; and in the foregoing solution, each regional server is only responsible for the logical computation of the corresponding virtual sub-world in the virtual world, and can effectively control computation load of each regional server; and in addition, the rendering tasks are performed by at least one rendering node device, and the regional server does not need to undertake the rendering task, whereby the computation load of the regional server can be further reduced. Therefore, the system including the foregoing regional server and the rendering node device can maintain the smoothness of the logical computation and picture rendering of the virtual world in a case of accommodating a large number of accessed terminals, thereby enhancing the efficiency of interaction between the user and the virtual world.

In this aspect described herein, the foregoing regional server undertakes a logical operation task in the corresponding virtual sub-world, and if a service of the virtual world (such as an application implementing cloud gaming) needs to be provided for the user through the cloud technology, a picture of the virtual world further needs to be rendered. In this aspect, the picture of the virtual world may be rendered by using the rendering node device.

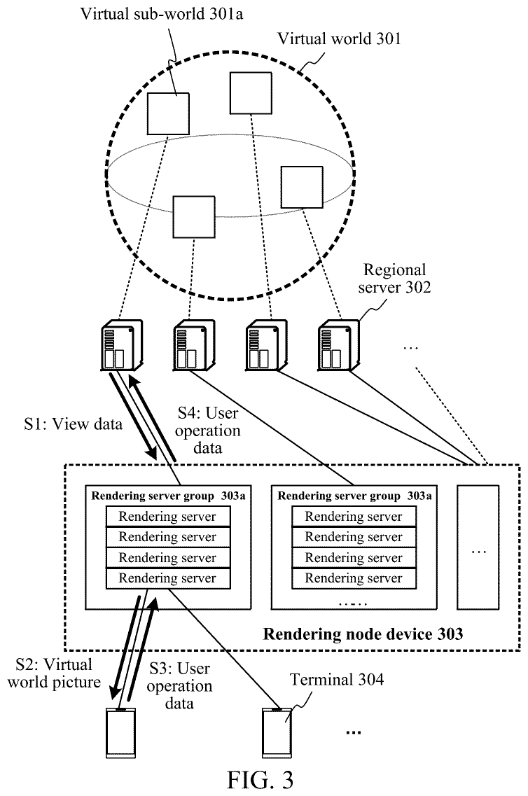

Based on the solution in the aspect shown in FIG. 2, FIG. 3 is a hardware architectural diagram of cloud gaming according to this application. As shown in FIG. 3, a hardware architecture of the cloud gaming includes at least one regional server 302, and each regional server 302 is configured to generate and maintain a virtual sub-world 301a in the virtual world 301, and undertake a game logical operation in the virtual sub-world 301a. The at least one regional server 302 may include the regional server 101 to the regional server 105 in an architecture shown in FIG. 1.

Each regional server 302 is respectively connected with at least one rendering node device 303, and correspondingly, each rendering node device 303 is respectively connected with at least one regional server 302. To be specific, each rendering node device 303 may render the virtual sub-world corresponding to any regional server 302. For example, each rendering node device 303 includes a rendering server group 303a respectively corresponding to at least one regional server 302, and each rendering server group 303a includes at least one rendering server.

Each rendering server may be connected to one or more terminals 304.

The at least one rendering node device 303 may be disposed in different geographical locations/address areas respectively, so that the terminals 304 of users in different regions can access the nearby rendering node device 303.

As shown in FIG. 3, a regional server 302 generates the view data of the corresponding virtual sub-world, and transmits the view data to each rendering node device 303 (operation S1); after a rendering node device 303 receives the view data, the view data is transmitted to each rendering server in the rendering server group 303a corresponding to the regional server; each rendering server renders the virtual world picture of the virtual sub-world according to the view data, and transmits the rendered virtual world picture to the terminal 304 accessing the rendering server (operation S2); when displaying the virtual world picture, the terminal 304 may further generate user operation information according to a received user operation, and transmit the user operation information to the corresponding rendering server (operation S3), and the corresponding rendering server forwards the user operation information to the corresponding regional server 302 (operation S4); and the regional server 302 may update the foregoing view data at a next moment based on an event corresponding to the user operation information and another possibly generated/received event, and transmit the updated view data to each rendering node device 303.

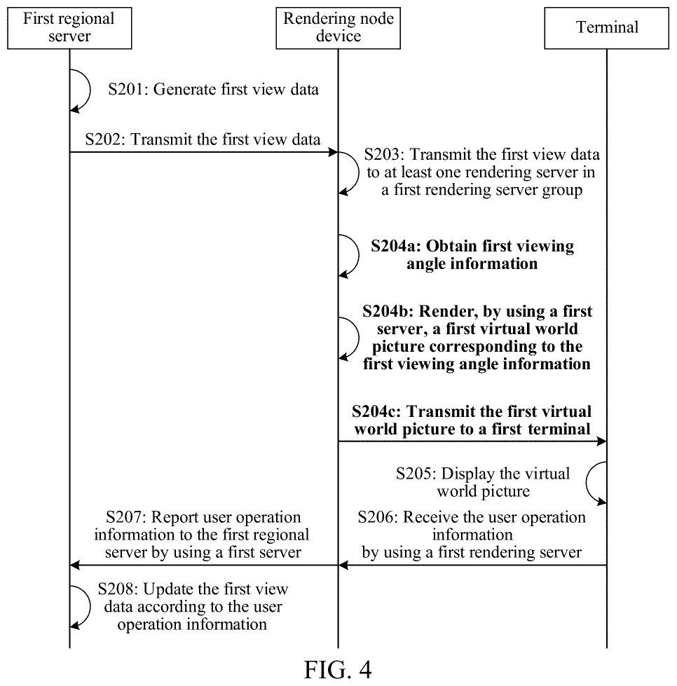

Based on the aspect shown in FIG. 2, FIG. 4 is a flowchart of a virtual world-based rendering method according to another exemplary aspect described herein. As shown in FIG. 4, operation 204 in the aspect shown in FIG. 2 may be implemented as operation 204a, operation 204b, and operation 204c.

Operation 204a: Obtain first viewing angle information, the first viewing angle information being viewing angle information of a first terminal correspondingly in a first virtual sub-world, and the first terminal being any one of terminals accessing the at least one rendering server.

In this aspect described herein, because the scope of a virtual sub-world may be extensive, the virtual object corresponding to the terminal usually can only observe a small area in the virtual sub-world, while the remaining larger areas may not be observed by the virtual object corresponding to any terminal, rendering the entire virtual sub-world by the rendering server may result in excessively large rendering load on the rendering server. To solve the problem, the rendering server may first obtain the viewing angle information corresponding to each accessing terminal during rendering.

The first viewing angle information may be configured for describing a viewing angle of a virtual object corresponding to the first terminal, such as a first-person viewing angle, a third-person viewing angle, a God's viewing angle, or an observer's viewing angle. For example, the viewing angle information may include information corresponding to the first terminal such as a camera location, a camera pose, and a visual field distance. The camera is a virtual camera, to collect a picture in the virtual world.

Operation 204b: Render a first virtual world picture corresponding to the first viewing angle information by using the first server, the first server being a rendering server where the first terminal accesses.

The first virtual world picture may be a virtual world picture observed by a virtual object corresponding to the first terminal. The virtual world picture may be a picture obtained by observing the virtual world.

The rendering server may render the virtual world picture corresponding to each terminal according to the viewing angle information corresponding to each terminal. When a quantity of terminals accessing the rendering server is limited, the rendering load of the rendering server can be greatly reduced, thereby reducing an occurrence probability of a frame freezing phenomenon, and improving the rendering effect of the rendering server.

Operation 204c: Transmit the first virtual world picture to the first terminal.

In some aspects, the rendering node device transmits the first virtual world picture to the first terminal by using the first server.

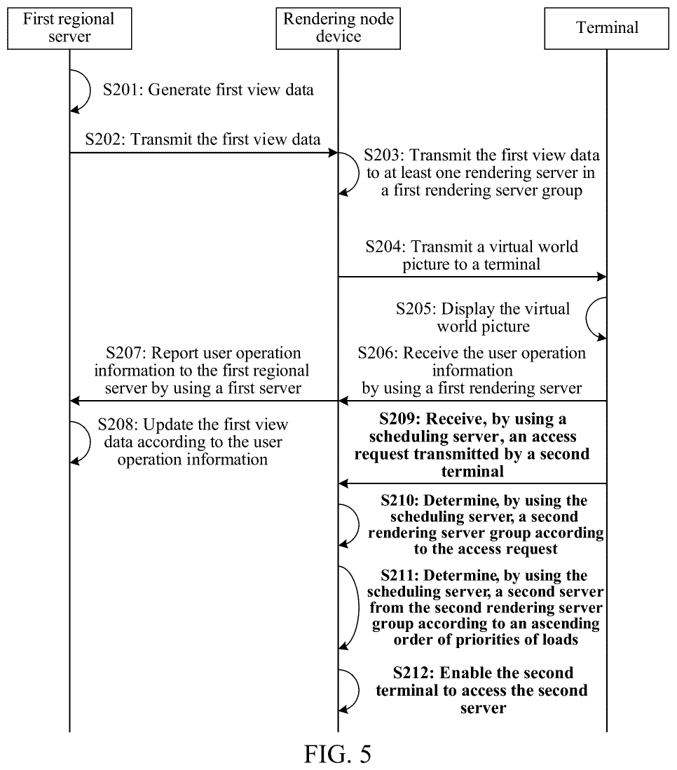

Based on the aspect shown in FIG. 2, FIG. 5 is a flowchart of a virtual world-based rendering method according to another exemplary aspect described herein. The rendering node device further includes a scheduling server; and as shown in FIG. 5, the aspect shown in FIG. 2 may further include operation 209, operation 210, operation 211, and operation 212.

Operation 209: Receive an access request transmitted by a second terminal by using the scheduling server.

In this aspect described herein, because the rendering node device includes a plurality of rendering server groups, each rendering server group further includes a plurality of rendering servers, and one terminal may access only one rendering server at a time, to improve the access efficiency and accuracy of the terminal, one scheduling server is set in the rendering node device, and an access behavior of the terminal is scheduled by using the scheduling server.

The second terminal may be a terminal to be connected to the rendering node device. The access request is configured for requesting the access to the rendering node device. For example, when the second terminal needs to access the rendering node device, the access request may be generated, and the access request may be transmitted to the nearby rendering node device. The rendering node device receives the access request by using the scheduling server.

Operation 210: Determine a second rendering server group by using the scheduling server according to the access request, the second rendering server group being a rendering server group corresponding to a second regional server in the rendering node device, and the second regional server being a regional server where the virtual object corresponding to the second terminal is located.

The scheduling server in this aspect described herein is configured to allocate the rendering servers. For example, when the scheduling server receives the access request of a terminal, which regional server the virtual object corresponding to the terminal is located needs to be determined first, namely, which rendering server in which rendering server group in the rendering node device the terminal needs to access is determined.

In a possible implementation, the access request includes identifier information of the second terminal, and the identifier information of the second terminal is configured for uniquely identifying the second terminal.

The operation in which a second rendering server group is determined by using the scheduling server according to the access request includes: whether the second virtual object exists in the corresponding regional server is queried by the scheduling server for at least one rendering server group in the rendering node device; the second virtual object is a virtual object corresponding to the second terminal; and the rendering server group corresponding to the regional server in which the second virtual object exists is determined as the second rendering server group.

In this aspect described herein, when the terminal corresponding to the virtual object in the virtual world is offline, the virtual object may still be active in the virtual world, and move from one virtual sub-world to another virtual sub-world. In this case, to ensure the access accuracy of the terminal, upon the access of the terminal, the scheduling server first determines that the virtual object corresponding to the terminal is currently located to the virtual sub-world corresponding to which regional server. Because the view data received by each rendering server group may indicate each visual element existing in a current virtual sub-world, and the virtual object is a visual element, the scheduling server may directly query, locally at the rendering node device and in a manner of querying the rendering server group, whether the virtual object corresponding to the terminal exists in the corresponding regional server, to determine the virtual server group to which the terminal currently needs to be connected, without querying the regional server of the virtual world, thereby reducing a communication requirement between the regional server and the rendering node device, and reducing an access load of the regional server.

In some aspects, the scheduling server may query the rendering server group in the rendering node device based on the identifier information of the second terminal, to determine whether the virtual object corresponding to the second terminal exists in the corresponding regional server.

In a possible implementation, the operation in which the second virtual object exists in the corresponding regional server is queried by the scheduling server for at least one rendering server group in the rendering node device includes: the scheduling server queries, locally at the rendering node device, an access record of the second terminal in the rendering node device, where the access record includes the regional server in which the second virtual object is located when the second virtual object quits the access last time; and the scheduling server obtains a query order for the at least one rendering server group based on a query result for the access record; and the scheduling server sequentially queries the at least one rendering server group in the rendering node device for whether the second virtual object exists in the corresponding regional server according to the query order, until the rendering server group corresponding to the regional server in which the second virtual object exists is found.

In this aspect described herein, the scheduling server may determine the query order for the rendering server groups according to the access record of the terminal on the current rendering node device, and sequentially perform the query according to the query order. The process may optimize the query order, and reduce the quantity of query times as much as possible, thereby reducing invalid query, improving the query efficiency, and further improving the access efficiency of the terminal.

Local of the rendering node device may refer to an internal memory corresponding to the rendering node device. The internal memory may be configured to store the access record. The access record may be configured for recording the regional server in which the virtual object corresponding to the terminal is located when the terminal quits the access. The query order for the rendering server groups is configured for indicating a query order for the rendering server groups in the rendering node device. Although the virtual object is still active when the terminal quits the access (is offline), the probability that the virtual object is located in the regional server when the terminal quits the access is relatively large. This facilitates the efficiency of determining the regional server.

In some aspects, the local of the rendering server may store a terminal identifier (i.e. identifier information) corresponding to each visual element used as the virtual object. In some aspects, the terminal identifier may be obtained by the rendering server from the view data, or may be separately transmitted to the rendering server by the corresponding regional server. When the scheduling server queries one rendering server group for whether the second virtual object exists in the corresponding regional server, a query request may be transmitted to one rendering server in the rendering server group. The query request may carry the terminal identifier (i.e. identifier information) of the currently accessed terminal (the second terminal). The rendering server queries for whether the terminal identifier of the second terminal is locally stored. If the rendering server locally stores the terminal identifier of the second terminal, a response of a successful query is returned to the scheduling server. After receiving the response, the scheduling server determines that the rendering server group where the rendering server is located is the rendering server group corresponding to the regional server where the second virtual object is located; and if the rendering server does not locally store the terminal identifier of the second terminal, the rendering server may return a query failure response to the scheduling server. After receiving the response, the scheduling server may continue to transmit the query request to a next rendering server group.

When the scheduling server queries one rendering server group for whether the second virtual object exists in the corresponding regional server, the query request may be transmitted to the rendering server with lowest load in the rendering server group; and this solution may reduce the impact of query request processing on a rendering task of the rendering server, to ensure the rendering effect.

In a possible implementation, the operation in which the scheduling server obtains a query order for the at least one rendering server group based on a query result for the access record includes: in response to the presence of the access record in the rendering node device, and based on an ascending order of a logical distance between the regional server where the second virtual object is located and another regional server of the at least one regional server when the terminal quits the access last time, the query order for the at least one rendering server group is determined.

When the terminal quits the access last time, the rendering server group corresponding to the regional server where the second virtual object is located is the first queried rendering server group. The logical distance refers to a distance of logical connection between the regional servers, and may be represented by a minimum quantity of information transfer nodes implementing the logical connection between the two. If two regional servers are connected directly through one information transfer node, the logical distance corresponding to the two regional servers is 1; and if the two regional servers are connected indirectly through two information transfer nodes, the logical distance corresponding to the two regional servers is 2.

Because the movement of the virtual object may be regarded as an event, and the event may be transferred between the two logically connected regional servers, when one virtual object moves between the virtual sub-worlds, the virtual object may usually move between the adjacent virtual sub-worlds according to a logical connection relationship between the regional servers. To be specific, after the terminal is offline, when the virtual object corresponding to the terminal moves across virtual sub-worlds, the virtual object may move gradually according to a neighboring relationship between the virtual sub-worlds. In view of this, in this aspect described herein, after the terminal accesses and logs off in one rendering node device, the rendering node device may save/update the access record of the terminal, to record the regional server where the corresponding virtual object is located when the terminal is offline. Subsequently, when the terminal re-accesses the rendering node device, the scheduling server may start from the regional server where the corresponding virtual object is located when the terminal is offline last time, to sequentially query the corresponding rendering server group according to an ascending order of the logical distance between another regional server and the present regional server, until the rendering server group where the virtual object is currently located is found, thereby greatly reducing duration required for query, and improving the access efficiency of the terminal.

In a possible implementation, the operation in which the scheduling server obtains a query order for the at least one rendering server group based on a query result for the access record includes: in response to the absence of the access record in the rendering node device, a specified arrangement order of the at least one rendering server group is determined as the query order for the at least one rendering server group.

In this aspect described herein, the terminal may geographically move, for example, move from a city to another city. Correspondingly, the rendering node devices accessed by the terminal may change before and after the terminal moves. In this case, the corresponding access record may not exist in the rendering node device to which the terminal is currently connected. In this case, the scheduling server may sequentially query the at least one rendering server group according to a pre-specified arrangement order, to support a new terminal to be connected to the current rendering node device. The specified arrangement order may be set and adjusted according to an empirical value. This is not limited in this application.

In some aspects, when no access record exists in the rendering node device, the scheduling server may further query the at least one rendering server group for whether the virtual object corresponding to the terminal exists, to ensure the access efficiency of the new terminal accessing the rendering node device.

Operation 211: Determine, by using the scheduling server, a second server from the second rendering server group according to an ascending order of priorities of loads.

The second server refers to the rendering server to which a second client in the rendering node device is to be connected. In this aspect described herein, the computation capacity of one rendering server is limited. If excessive terminals are connected to one rendering server, the rendering effect of the rendering server may be affected, and frame freezing may easily occur. Therefore, in the solution shown in this aspect described herein, when scheduling the access of the terminal, after determining the rendering server group corresponding to the terminal, the scheduling server may select one rendering server with a relatively low load/lowest load in the rendering servers according to the ascending order of priorities of the loads, thereby avoiding an imbalance of the quantity of the terminals accessing the rendering servers, and ensuring the rendering effect of the rendering servers.

Operation 212: Allow the second terminal to access the second server.

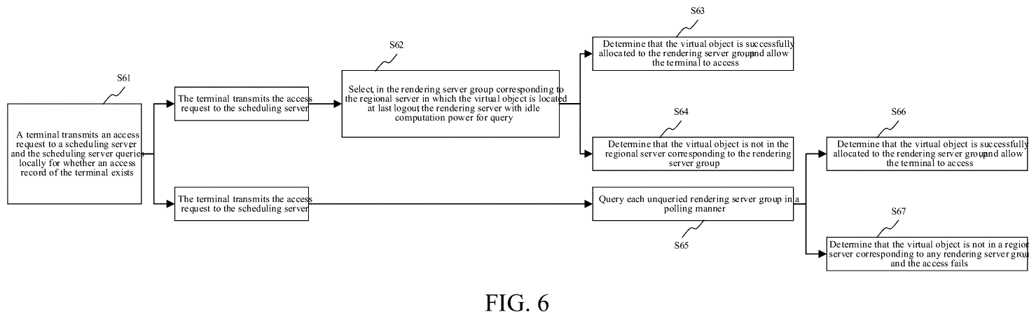

FIG. 6 is a schematic diagram of a terminal access process according to an aspect described herein. As shown in FIG. 6, a process in which a terminal accesses a rendering node device may be as follows:

S61: the terminal transmits an access request to a scheduling server in the rendering node device; and the scheduling server queries whether an access record of the terminal exists locally, and if the access record exists, S62 is performed, and if the access record does not exist, S65 is performed;

S62: the scheduling server selects, in the rendering server group corresponding to a regional server in which the virtual object of the terminal is located at last logout indicated by the access record, the rendering server with idle computing power (the lowest load) for query, to query whether the virtual object of the terminal exists in the corresponding regional server; and if the virtual object of the terminal exists in the corresponding regional server, S63 is performed; and if the virtual object of the terminal does not exist in the corresponding regional server, S64 is performed;

S63: the scheduling server determines that the virtual object is successfully allocated to the rendering server group, and the terminal accesses one rendering server with relatively low load in the rendering server group;

S64: it is determined that the virtual object is not in the regional server corresponding to the rendering server group, and S65 is performed;

S65: the scheduling server queries each rendering server group that is not queried in a polling manner to determine whether the virtual object of the terminal exists in the corresponding regional server; and if the virtual object of the terminal exists in the corresponding regional server, S66 is performed; and if the virtual object of the terminal does not exist in the corresponding regional server, S67 is performed;

S66: it is determined that the virtual object is successfully allocated to the rendering server group in which the virtual object is found, and the scheduling server allows the terminal to access one rendering server with a relatively low load in the rendering server group; and

S67: it is determined that the virtual object is not in a corresponding regional server of any rendering server group, and the access fails.

If the virtual object corresponding to the terminal is removed in an offline period of the terminal, or the virtual object corresponding to the terminal is in a process of moving from one virtual sub-area to another virtual sub-area, the corresponding virtual object may not be found in all rendering server groups. In this case, a query failure occurs. In the case of S67, the scheduling server may further re-initiate the query process. If the regional server in which the virtual object is located is not found when the quantity of times of performing the query process reaches a threshold, the scheduling server may return an access failure response to the terminal.

In a possible implementation, in response to the absence of the rendering server meeting load requirements in the second rendering server group, or in response to that the load of each rendering server in the second rendering server group reaches a load threshold, the rendering node device starts a new rendering server, and adds the new rendering server into the second rendering server group.

In this aspect described herein, if the scheduling server receives an access request of a terminal, and each rendering server in the rendering server group corresponding to the terminal has a relatively high load, the scheduling server then may start the new rendering server, and add the new rendering server into the corresponding rendering server group, to achieve an effect of flexibly extending the rendering server group, thereby reducing resource consumption and ensuring the rendering effect. The requirement and load threshold may be set and adjusted according to the empirical value. This is not limited in this aspect described herein.

In a possible implementation, in response to the presence of the idle rendering server in the second rendering server group, the rendering node device shuts down the idle rendering server.

In this aspect described herein, the terminal may quit the access to the rendering server. For example, at a trough of access (i.e. a period of time when few terminals are connected), it is possible that all terminals in the running rendering servers in the rendering server group quit the access. In this case, the scheduling server may control the rendering servers without terminal access to shut down, thereby saving electrical power.

In addition, when a plurality of rendering servers having relatively low load exist in one rendering server group, the scheduling server may further perform terminal migration among the plurality of rendering servers having relatively low load, namely, migrate the terminal accessing the plurality of rendering servers to one rendering server, and shut down the remaining rendering servers, thereby saving the electrical power.

Through the solution shown in this aspect described herein, a cloud gaming mode may be used to allocate a gaming view of each regional server in a gaming world (i.e. the foregoing virtual world) to computer rooms (i.e. the rendering node device) in different geographical locations. The game pictures are rendered to nearby game users in these computer rooms, to ensure consistent game experience.

For example, in the solution shown in this aspect described herein, a cloud gaming mechanism is introduced, and the rendering task is allocated to the independent rendering server for execution. In this case, the server (the regional server) of the gaming world only performs game logical operations in a world view, and the terminal of the user only displays a game video stream.

This aspect does not limit an application program providing the gaming world, and the application program may include at least one of the following: a massive multi-player online role-playing game (MMORPG), a recreational game, a party game, a sandbox game, a tower defense game, an action adventure game, a multi-player online battle arena (MOBA) game, a first-person shooting (FPS) game, a multi-player shooter survival game, a third-person shooting (TPS) game, and a simulation game (SLG).

FIG. 7 is a structural diagram of hardware deployment of a cloud gaming world according to this application. Composition and responsibility of layers of a hardware deployment structure are as follows:
(1) A gaming world 71 is established and run by a regional server cluster. The regional server cluster is unique in the cloud gaming world and carries all scenario data and player logical data in the gaming world.
2) A local cloud node 72 (i.e. the foregoing rendering node device) is scattered in different geographical locations in the real world, and provides a game picture rendering output capability and an operation forwarding capability for a player, to enable the player to keep communication (interaction) with the gaming world.
3) The user terminal 73 merely displays a picture (such as a virtual world picture) and transfers a user input (such as user operation information).

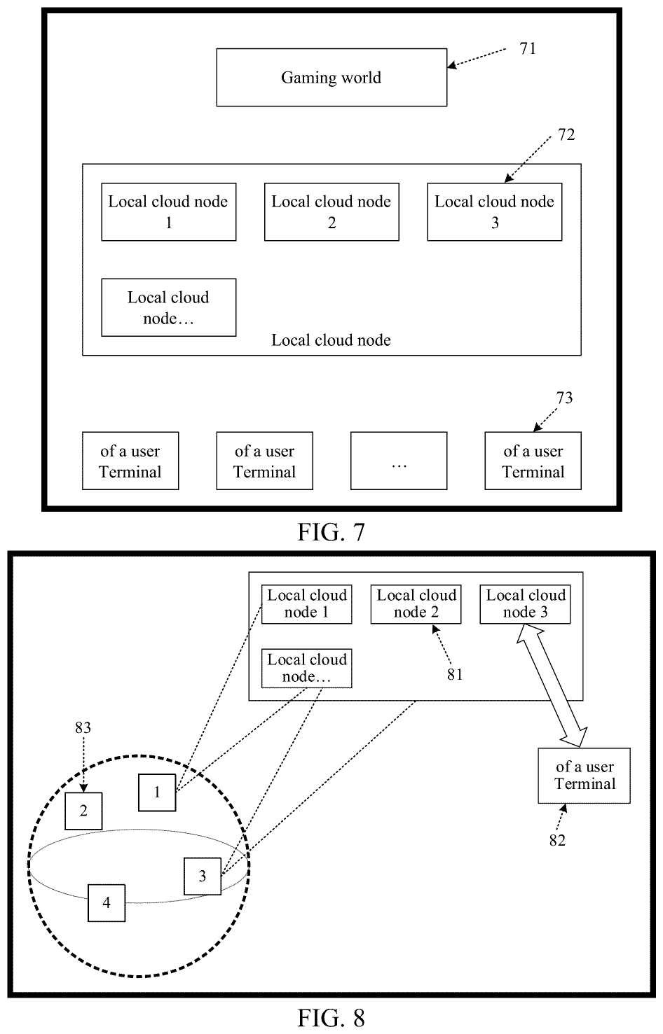

FIG. 8 is a schematic diagram of a connection between a regional server and a local cloud node according to this application. As shown in FIG. 8, a local cloud node 81 is a local computer room in a geographical location. A quantity of local cloud nodes is a constant, and does not expand as a gaming world expands.

The local cloud node is responsible for picture rendering and user operation transfer of terminals 82 of all users nearby in the geographical locations. The user operation herein is not processed on the local cloud node, but is transferred into the regional server through the local cloud node for processing.

In this aspect described herein, data of all players in a same regional server 83 may be synchronized (for example, a logical operation) at a regional server level, and share a same clock, namely, their rendering scenarios are time-synchronized. In view of this, in this aspect described herein, in each operation cycle, only one piece of complete view data of the current regional server is transmitted from one regional server to all local cloud nodes.

It may be learned from the characteristics of the above local cloud nodes that, each regional server needs to be directly connected with all local cloud nodes, because the players, regardless of their physical locations, may migrate to any regional server (i.e., any gaming sub-world) corresponding to the gaming world.

Because the quantity of local cloud nodes is a constant, the quantity of connections between each regional server in the gaming world and the local cloud nodes is a constant. In addition, as can be known from the foregoing discussion of the gaming world, the quantity of connections between the regional server and the gaming world is further a constant, and therefore, the computation load of each regional server on an external connection is permanently a constant.

On the contrary, from the perspective of the local cloud nodes, if each local cloud node has only one server, the connection load on the gaming world increases at a speed of 0 (n) as the quantity of regional servers increases. In addition, the connection load of the local cloud nodes to the terminal of the user further increases at a speed of 0 (n) with the quantity of the user terminals. The increase finally leads to that the local cloud nodes cannot bear the connection load. Therefore, the local cloud nodes may be set as a cluster.

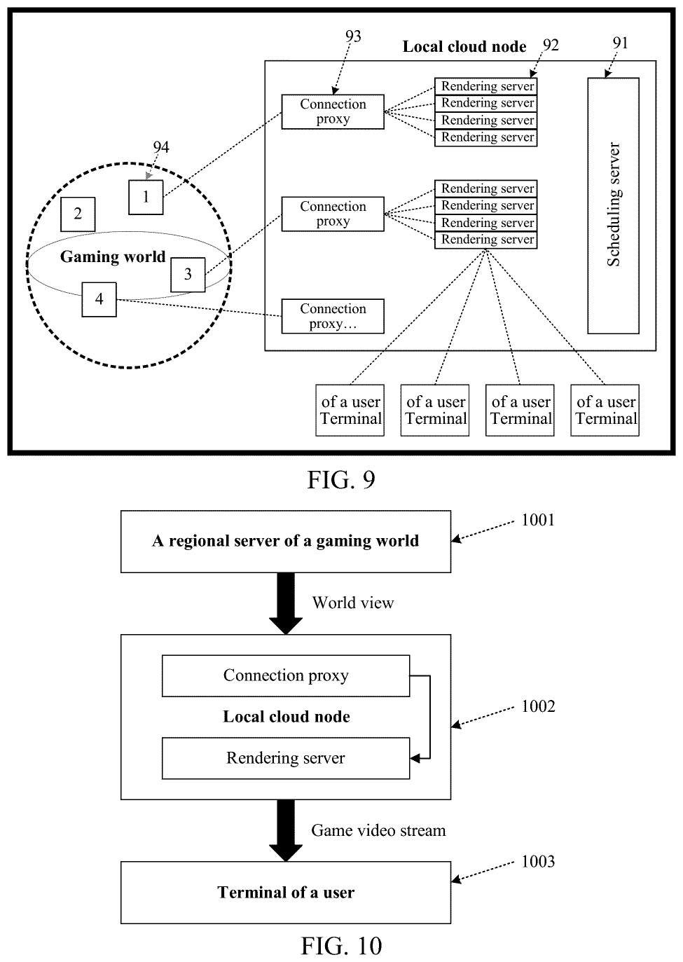

FIG. 9 is a schematic structural diagram of a local cloud node according to this application. As shown in FIG. 9, each local cloud node includes a cluster formed by a scheduling server 91 in conjunction with a plurality of rendering servers 92, each rendering server 92 serves a limited quantity of users, and a scale of the cluster increases as users increase.

A group of rendering servers 92 connected to a same regional server is connected to a corresponding regional server 94 by using a connection proxy 93. The connection proxy 93 and the regional server 94 are in a one-to-one correspondence. In this way, it can be ensured that each regional server only has one connection to a single local cloud node. The quantity increase of the regional servers may result in the quantity increase of connection proxies in all local cloud nodes, and a group of rendering servers may further be correspondingly added to the connection proxies.

The scheduling server 91 is responsible for allocating the corresponding rendering server to the user according to the regional server in which the user is currently located. In most cases, the geographical location of the user is not changed, and the scheduling server records the regional server in which the connected user is located, so that the scheduling server may starts the polling query from the regional server for the regional server where the user currently needs to access in a next access.

FIG. 10 is a schematic diagram of generation and transmission of a game picture according to this application. As shown in FIG. 10, the process may include:
1) Each regional service 1001 of the gaming world cyclically outputs a complete world view (corresponding to the foregoing view data) in the regional server according to a work cycle (i.e. the foregoing operation cycle) of the regional server. These world views are formed by smallest element units (virtual elements) that are indivisible in the regional server, and these world views are allocated to all local cloud nodes 1002 at the same time.
2) The connection proxy on the local cloud node 1002 receives the world view information from the regional server and then allocates the world view information to each rendering server.
3) The rendering server is loaded with models and textures of virtual elements in all the world views, and a picture of any part in the world view may be rendered according to the received world view information. Because a quantity of users connected to the rendering server is limited, only the game picture within a field of view of character elements of all connected users needs to be selected.
4) The rendering server encodes consecutive game pictures into a game video stream and transmits the game video stream to the terminal 1003 of the user for display.
5) The terminal 1003 of the user decodes the video stream and displays the decoded video stream to the user. It can be seen from the foregoing process that game elements seen by all players in a same regional server are consistent, but viewing angles are different according to character locations and directions.

In this aspect described herein, an operation of the user may be transferred to the gaming world as a game event. The event affects the entire gaming world, and may immediately affect a basic computing unit in the current regional server of the user, or may affect another basic computing unit in the same regional server or even another regional server later.

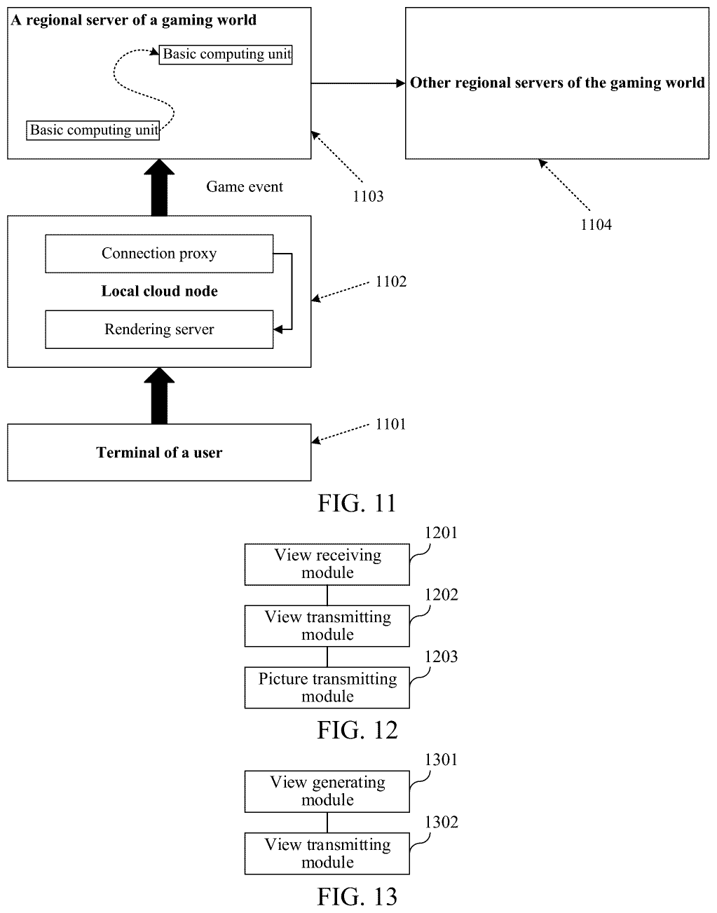

FIG. 11 is a schematic diagram of propagation of a game event according to this application. As shown in FIG. 11, the process may include:
1) Input information (such as user operation information) of a user is transmitted from a terminal device 1101 to a rendering server in a local cloud node 1102.
2) The rendering server encapsulates the input information into an event in the gaming world, and forwards the event to a regional server 1103 in which a game character corresponding to the user is located through a connection proxy.
3) The regional server 1103 selects a basic computing unit where the game character is located for delivery, and the corresponding computing unit immediately processes the event after receiving the event. At this moment, the world view in the basic computing unit may change correspondingly under the impact of the event (such as a user operation). At this moment, other parts in the gaming world are not affected by the event. The thought of a limited game information transfer speed is embodied herein.
4) Subsequently, if only the world view (such as a game view) inside the computing unit is changed, and no additional event crossing the basic computing unit is generated, the current event is ended.
5) If this event causes the world view in this computing unit to transmit an event crossing the basic computing unit, the newly generated event may continue to affect another part of the gaming world (namely, the event is transferred to another regional server 1104) in a subsequent computing cycle.

The impact of the user operation on the gaming world may be summarized as follows: the user operation may affect an entire gaming world, but due to the limitation of the information transfer speed in the gaming world, the impact may be embodied later.

From the perspective of consistency of the world view, all game pictures in the regional server are synchronous. From the perspective of the user input, the user input that is not in a same basic computing unit is not synchronous.

In the solution shown in this aspect described herein, based on the principle of modern physics, an unbounded and unlimited cloud gaming world may be established, and the users can be accessed based on the cloud gaming technologies. The gaming world and the quantity of players may be extended in different manners, and all players may enjoy consistent and brand-new game experience.

For example, FIG. 12 is a structural block diagram of a virtual world-based rendering apparatus according to an exemplary aspect described herein. At least one rendering server group included in a rendering node device is in a one-to-one correspondence with at least one regional server configured to employ a virtual world; each regional server corresponds to one virtual sub-world in the virtual world; and the apparatus includes:

a view receiving module 1201, configured to receive first view data transmitted by a first regional server of the at least one regional server, the first view data being configured for indicating a visual element included in a first virtual sub-world, and the first virtual sub-world being a virtual sub-world corresponding to the first regional server in the virtual world;

a view transmitting module 1202, configured to transmit the first view data to at least one rendering server in a first rendering server group, the first rendering server group being a rendering server group corresponding to the first virtual sub-world in the rendering node device; and

a picture transmitting module 1203, configured to transmit a virtual world picture rendered by the at least one rendering server to a terminal accessing the at least one rendering server.

In a possible implementation, the picture transmitting module 1203 is configured to:

obtain first viewing angle information, the first viewing angle information being viewing angle information of a first terminal correspondingly in the first virtual sub-world, and the first terminal being any one of terminals accessing the at least one rendering server; and

render a first virtual world picture corresponding to the first viewing angle information by using a first server, the first server being a rendering server to which the first terminal is connected; and

transmit the first virtual world picture to the first terminal.

In a possible implementation, the rendering node device further includes a scheduling server; the apparatus further includes:

a request receiving module, configured to receive an access request transmitted by a second terminal by using the scheduling server;

a group determining module, configured to determine a second rendering server group according to the access request by using the scheduling server, the second rendering server group being a rendering server group corresponding to a second regional server in the rendering node device, and the second regional server being a regional server in which a virtual object corresponding to the second terminal is located;

a server determining module, configured to determine a second server from the second rendering server group according to an ascending order of priorities of loads by using the scheduling server; and

an access module, configured to enable the second terminal to access the second server.

In a possible implementation, the apparatus further includes:

a startup module, configured to start a new rendering server in response to the absence of a rendering server meeting load requirements in the second rendering server group, or in response to that a load of each rendering server in the second rendering server group reaches a load threshold, and add the new rendering server to the second rendering server group.

In a possible implementation, the apparatus further includes:

a shut-down module, configured to shut down, in response to the presence of an idle rendering server in the second rendering server group, the idle rendering server.

In a possible implementation, the access request includes identifier information of the second terminal; and the group determining module is configured to:

query at least one rendering server group in the rendering node device for whether a second virtual object exists in the corresponding regional server by using the scheduling server, the second virtual object being a virtual object corresponding to the second terminal; and

determine the rendering server group corresponding to the regional server in which the second virtual object exists as the second rendering server group.

In a possible implementation, the group determining module is configured to:

query, locally at the rendering node device, an access record of the second terminal in the rendering node device by using the scheduling server, the access record including the regional server in which the second virtual object is located when the second terminal quits the access last time;

obtain a query order for the at least one rendering server group based on a query result for the access record by using the scheduling server; and

sequentially query, by using the scheduling server, the at least one rendering server group for whether the second virtual object exists in the corresponding regional server according to the query order, until the rendering server group corresponding to the regional server in which the second virtual object exists is found.

In a possible implementation, the group determining module is configured to, in response to the presence of the access record in the rendering node device, determine a query order for the at least one rendering server group based on an ascending order of a logical distance between the regional server in which the second virtual object is located and another regional server of the at least one regional server when the second terminal quits the access last time,

where the rendering server group corresponding to the regional server in which the second virtual object is located when the second terminal quits the access last time is the first queried rendering server group.

In a possible implementation, the group determining module is configured to determine, in response to the absence of the access record in the rendering node device, a specified arrangement order of the at least one rendering server group as the query order for the at least one rendering server group.

In a possible implementation, the apparatus further includes:

an operation information receiving module, configured to receive user operation information reported by the first terminal by using the first server; and

an operation information reporting module, configured to report the user operation information to the first regional server by using the first server, causing the first regional server to update the first view data based on the user operation information.

In a possible implementation, the rendering node device further includes at least one access proxy; the at least one access proxy is in a one-to-one correspondence with the at least one rendering server group, and the at least one access proxy is in a one-to-one correspondence with the at least one regional server;

the view receiving module 1201 is configured to receive the first view data transmitted by the first regional server by using the first access proxy, the first access proxy being connected respectively with the at least one rendering server in the first rendering server group; and

the view transmitting module 1202 is configured to transmit the first view data respectively to the at least one rendering server in the first rendering server group through the first access proxy.

FIG. 13 is a structural block diagram of a virtual world-based rendering apparatus according to another exemplary aspect described herein. A first regional server is any regional server of at least one regional server configured to deploy a virtual world; each regional server corresponding to the virtual world is respectively connected with at least one rendering node device, and at least one rendering server group included in each rendering node device is in a one-to-one correspondence with the at least one regional server; each regional server corresponds to one virtual sub-world in the virtual world, and the apparatus includes:

a view generating module 1301, configured to generate first view data, the first view data being configured for indicating a visual element included in a first virtual sub-world, and the first virtual sub-world being a virtual sub-world corresponding to the first regional server in the virtual world; and

a view transmitting module 1302, configured to transmit the first view data respectively to the at least one rendering node device, whereby the rendering node device transmits the first view data to at least one rendering server in a first rendering server group, and transmits a virtual world picture rendered by the at least one rendering server to a terminal accessing the at least one rendering server, the first rendering server group being a rendering server group corresponding to the first virtual sub-world in the rendering node device.

In a possible implementation, the apparatus further includes:

an operation data receiving module, configured to receive user operation information transmitted by the rendering server; and

a view updating module, configured to update the first view data based on the user operation information.

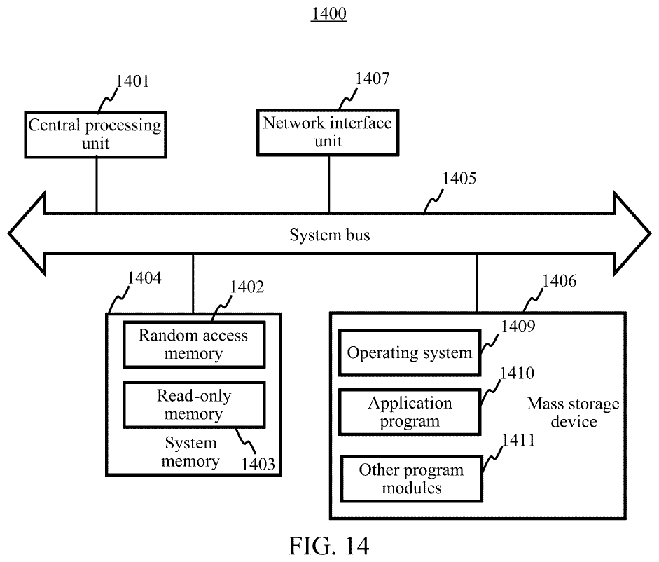

FIG. 14 is a structural block diagram of a computer device 1400 according to an exemplary aspect described herein. The computer device 1400 can be implemented as a cloud server or a service back-end server in the foregoing solution described herein. The computer device 1400 includes a central processing unit (CPU) 1401, a system memory 1404 including a random access memory (RAM) 1402 and a read-only memory (ROM) 1403, and a system bus 1405 connecting the system memory 1404 and the CPU 1401. The computer device 1400 further includes a mass storage device 1406 configured to store an operating system 1409, an application program 1410, and another program module 1411.

The mass storage device 1406 is connected to the CPU 1401 by using a mass storage controller (not shown) connected to the system bus 1405. The mass storage device 1406 and an associated computer-readable medium provide non-volatile storage for the computer device 1400. In other words, the mass storage device 1406 may include a computer-readable medium (not shown) such as a hard disk or a compact disc read-only memory (CD-ROM) drive.

Generally, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, an erasable programmable ROM (EPROM), an electrically-erasable programmable ROM (EEPROM), a flash memory or another solid-state memory technology, a CD-ROM, a digital versatile disc (DVD) or another optical memory, a magnetic cassette, a magnetic tape, a magnetic disk memory, or another magnetic storage device. Certainly, a person skilled in the related art can learn that the computer storage medium is not limited to the foregoing several types. The system memory 1404 and the mass storage device 1406 may be collectively referred to as a memory.

According to the aspects of the present disclosure, the computer device 1400 may be further connected, through a network such as the Internet, to a remote computer on the network and run. To be specific, the computer device 1400 may be connected to a network by using a network interface unit 1407 connected to the system bus 1405, or may be connected to another type of network or a remote computer system (not shown) by using a network interface unit 1407.

The memory further includes at least one piece of computer program. The at least one piece of computer program is stored in the memory. The central processing unit 1401 executes the at least one piece of computer program to implement all or some operations, performed by a cloud server or a service back-end server, in the method shown in the foregoing aspects.

In an exemplary aspect, a computer-readable storage medium is further provided, and configured to store at least one piece of computer program stored, the at least one computer program being loaded and executed by a processor to implement all or some operations in the method shown in the foregoing aspects. For example, the computer-readable storage medium may be a read-only memory, a random access memory, an optical disc read-only memory, a magnetic tape, a floppy disk, or an optical data storage device.

In an exemplary aspect, a computer program product is further provided. The computer program product includes a computer program. The computer program is stored in a computer-readable storage medium. A processor of a computer device reads the computer program from the computer-readable storage medium and executes the computer program, to cause the computer device to perform all or some operations in the method in the foregoing aspects.

In addition, in this application, a prompt interface or a pop-up window can be displayed, or voice prompt information can be outputted before collecting user-related data and when collecting user-related data. The prompt interface, the pop-up window, or the voice prompt information is configured for prompting the user that user-related data is currently being collected. In this way, in this application, related operations of obtaining the user-related data only start to be executed after obtaining a confirmation operation of the user on the prompt interface or the pop-up window. Otherwise (that is, the confirmation operation of the user on the prompt interface or the pop-up window is not obtained), the related operations of obtaining the user-related data are ended, that is, the user-related data is not obtained.

In other words, in this application, all collected user data are collected with the consent and authorization of users. The collection, use, and processing of relevant user data need to comply with the relevant laws, regulations, and standards of relevant countries and regions.

The related data of the user includes data such as information (including but not limited to an account of the user), data (including but not limited to user operation information, an access record of the user), and a signal. For example, the view data, virtual world picture, user operation information, and the like involved in this application are obtained with full authorization.

“Plurality of” mentioned in the specification means two or more. “And/or” describes an association relationship for describing associated objects, and represents that three relationships may exist. For example, A and/or B may represent the following three cases: only A exists, both A and B exist, and only B exists. The character “/” in this specification generally indicates an “or” relationship between the associated objects.

The foregoing descriptions are merely exemplary aspects described herein, but are not intended to limit this application. Any modification, equivalent replacement, or improvement made within the spirit and principle described herein shall fall within the protection scope described herein.

What is claimed is:

1. A method comprising:
receiving, by a rendering node device comprising a first rendering server group having a one-to-one correspondence with a first regional server, first view data transmitted by the first regional server, the first view data being configured for indicating a visual element comprised in a first virtual sub-world of a virtual world, and the first virtual sub-world being a virtual sub-world corresponding to the first regional server; and
transmitting the first view data to at least one rendering server in the first rendering server group, the first rendering server group being a rendering server group corresponding to the first virtual sub-world in the rendering node device; and
transmitting a virtual world picture rendered by the at least one rendering server to a terminal accessing the at least one rendering server.

2. The method according to claim 1, wherein the transmitting the virtual world picture comprises:
obtaining first viewing angle information, the first viewing angle information being viewing angle information of a first terminal correspondingly in the first virtual sub-world, and the first terminal being any one of terminals accessing the at least one rendering server;
rendering, by using a first rendering server, a first virtual world picture corresponding to the first viewing angle information, the first rendering server being a rendering server to which the first terminal is connected; and
transmitting the first virtual world picture to the first terminal.

3. The method according to claim 1, wherein the rendering node device further comprises a scheduling server, and the method further comprises:
receiving, by the scheduling server, an access request transmitted by a second terminal;
determining, by the scheduling server, a second rendering server group according to the access request, the second rendering server group being a rendering server group corresponding to a second regional server in the rendering node device, and the second regional server being a regional server in which a virtual object corresponding to the second terminal is located;
determining, by using the scheduling server, a second server from the second rendering server group based on an ascending order of priorities of loads; and
enabling the second terminal to access the second server.

4. The method according to claim 3, the method further comprising:
starting a new rendering server in response to the absence of a rendering server meeting load requirement in the second rendering server group, or in response to that a load of each rendering server in the second rendering server group reaches a load threshold, and adding the new rendering server to the second rendering server group.

5. The method according to claim 3, further comprising:
shutting down, in response to that an idle rendering server exists in the second rendering server group, the idle rendering server.

6. The method according to claim 3, wherein the access request comprises identifier information of the second terminal;
wherein the determining, by using the scheduling server, a second rendering server group according to the access request comprises:
querying, by using the scheduling server, at least one rendering server group in the rendering node device for whether a second virtual object exists in the corresponding regional server, the second virtual object being a virtual object corresponding to the second terminal; and
determining the rendering server group corresponding to the regional server in which the second virtual object exists as the second rendering server group.

7. The method according to claim 6, wherein the querying, by the scheduling server, at least one rendering server group in the rendering node device for whether a second virtual object exists in the corresponding regional server comprises:
querying, locally at the rendering node device, an access record of the second terminal in the rendering node device by using the scheduling server, the access record comprising the regional server in which the second virtual object is located when the second terminal quits the access last time;
obtaining a query order for the at least one rendering server group based on a query result for the access record by using the scheduling server; and
sequentially querying, by the scheduling server, the at least one rendering server group for whether the second virtual object exists in the corresponding regional server according to the query order, until the rendering server group corresponding to the regional server in which the second virtual object exists is found.

8. The method according to claim 7, wherein the obtaining a query order for the at least one rendering server group based on a query result for the access record by using the scheduling server comprises:
determining, in response to the presence of the access record in the rendering node device, the query order for the at least one rendering server group based on an ascending order of a logical distance between the regional server in which the second virtual object is located and another regional server in the at least one regional server when the second terminal quits the access last time,
wherein the rendering server group corresponding to the regional server in which the second virtual object is located when the second terminal quits the access last time is the first queried rendering server group.

9. The method according to claim 7, wherein the obtaining a query order for the at least one rendering server group based on a query result for the access record by using the scheduling server comprises:
determining, in response to the absence of the access record in the rendering node device, a specified arrangement order of the at least one rendering server group as the query order for the at least one rendering server group.

10. The method according to claim 2, further comprising:
receiving, by the first rendering server, user operation information reported by the first terminal; and
reporting, by the first rendering server, the user operation information to the first regional server, whereby the first regional server updates the first view data according to the user operation information.

11. The method according to claim 1, wherein the rendering node device further comprises at least one access proxy, wherein the at least one access proxy is in a one-to-one correspondence with the at least one rendering server group, and the at least one access proxy is in a one-to-one correspondence with the at least one regional server;
the receiving first view data transmitted by a first regional server of the at least one regional server comprises:
receiving the first view data transmitted by the first regional server through the first access proxy, the first access proxy being connected respectively with the at least one rendering server in the first rendering server group; and
the transmitting the first view data to at least one rendering server in a first rendering server group comprises:
transmitting the first view data respectively to the at least one rendering server in the first rendering server group through the first access proxy.

12. One or more non-transitory computer readable media storing computer readable instructions which, when executed by a processing device, configure a system to perform:
receiving, by a rendering node device comprising a first rendering server group having a one-to-one correspondence with a first regional server, first view data transmitted by the first regional server, the first view data being configured for indicating a visual element comprised in a first virtual sub-world of a virtual world, and the first virtual sub-world being a virtual sub-world corresponding to the first regional server; and
transmitting the first view data to at least one rendering server in the first rendering server group, the first rendering server group being a rendering server group corresponding to the first virtual sub-world in the rendering node device; and
transmitting a virtual world picture rendered by the at least one rendering server to a terminal accessing the at least one rendering server.

13. The computer readable media according to claim 12, wherein the transmitting the virtual world picture comprises:
obtaining first viewing angle information, the first viewing angle information being viewing angle information of a first terminal correspondingly in the first virtual sub-world, and the first terminal being any one of terminals accessing the at least one rendering server;
rendering, by using a first rendering server, a first virtual world picture corresponding to the first viewing angle information, the first rendering server being a rendering server to which the first terminal is connected; and
transmitting the first virtual world picture to the first terminal.

14. The computer readable media according to claim 12, wherein the rendering node device further comprises a scheduling server, and the computer readable instructions further configure the system to perform:
receiving, by the scheduling server, an access request transmitted by a second terminal;
determining, by the scheduling server, a second rendering server group according to the access request, the second rendering server group being a rendering server group corresponding to a second regional server in the rendering node device, and the second regional server being a regional server in which a virtual object corresponding to the second terminal is located;
determining, by using the scheduling server, a second server from the second rendering server group based on an ascending order of priorities of loads; and
enabling the second terminal to access the second server.

15. The method according to claim 14, wherein the access request comprises identifier information of the second terminal;
wherein the determining, by using the scheduling server, a second rendering server group according to the access request comprises:
querying, by using the scheduling server, at least one rendering server group in the rendering node device for whether a second virtual object exists in the corresponding regional server, the second virtual object being a virtual object corresponding to the second terminal; and
determining the rendering server group corresponding to the regional server in which the second virtual object exists as the second rendering server group.

16. The computer readable instructions according to claim 15, wherein the querying, by the scheduling server, at least one rendering server group in the rendering node device for whether a second virtual object exists in the corresponding regional server comprises:
querying, locally at the rendering node device, an access record of the second terminal in the rendering node device by using the scheduling server, the access record comprising the regional server in which the second virtual object is located when the second terminal quits the access last time;
obtaining a query order for the at least one rendering server group based on a query result for the access record by using the scheduling server; and
sequentially querying, by the scheduling server, the at least one rendering server group for whether the second virtual object exists in the corresponding regional server according to the query order, until the rendering server group corresponding to the regional server in which the second virtual object exists is found.

17. The computer readable instructions according to claim 16, wherein the obtaining a query order for the at least one rendering server group based on a query result for the access record by using the scheduling server comprises:
determining, in response to the presence of the access record in the rendering node device, the query order for the at least one rendering server group based on an ascending order of a logical distance between the regional server in which the second virtual object is located and another regional server in the at least one regional server when the second terminal quits the access last time,
wherein the rendering server group corresponding to the regional server in which the second virtual object is located when the second terminal quits the access last time is the first queried rendering server group.

18. The computer readable instructions according to claim 16, wherein the obtaining a query order for the at least one rendering server group based on a query result for the access record by using the scheduling server comprises:
determining, in response to the absence of the access record in the rendering node device, a specified arrangement order of the at least one rendering server group as the query order for the at least one rendering server group.

19. The method according to claim 12, wherein the rendering node device further comprises at least one access proxy, wherein the at least one access proxy is in a one-to-one correspondence with the at least one rendering server group, and the at least one access proxy is in a one-to-one correspondence with the at least one regional server;
the receiving first view data transmitted by a first regional server of the at least one regional server comprises:
receiving the first view data transmitted by the first regional server through the first access proxy, the first access proxy being connected respectively with the at least one rendering server in the first rendering server group; and
the transmitting the first view data to at least one rendering server in a first rendering server group comprises:
transmitting the first view data respectively to the at least one rendering server in the first rendering server group through the first access proxy.

20. A rendering node data processing device, comprising:
a processor, and
memory storing computer readable instructions which, when executed by the processor, configure the data processing device to perform:
receiving, by the rendering node data processing device comprising a first rendering server group having a one-to-one correspondence with a first regional server, first view data transmitted by the first regional server, the first view data being configured for indicating a visual element comprised in a first virtual sub-world of a virtual world, and the first virtual sub-world being a virtual sub-world corresponding to the first regional server; and
transmitting the first view data to at least one rendering server in the first rendering server group, the first rendering server group being a rendering server group corresponding to the first virtual sub-world in the rendering node device; and
transmitting a virtual world picture rendered by the at least one rendering server to a terminal accessing the at least one rendering server.
